(19) United States
(12) Patent Application Publication
(10) Pub. No.: US 2012/0137132 A1
(43) Pub. Date: May 31, 2012

(54) SHARED SECRET ESTABLISHMENT AND DISTRIBUTION

(76) Inventor: Eric F. Le Saint, Los Altos, CA (US)

(21) Appl. No.: 13/238,668

(22) Filed: Sep. 21, 2011

Related U.S. Application Data
(60) Provisional application No. 61/403,781, filed on Sep. 21, 2010.

(51) Int. Cl. H04L 9/00

(52) U.S. Cl. 713/171

(57) ABSTRACT

Providing secure communication with a security token includes establishing a shared secret between the security token and a first entity, transferring the shared secret between the first entity and a second entity, and the security token and the second entity establishing a secure communication channel using the shared secret. Transferring the shared secret may include selectively transferring the shared secret to a subset of entities according to access considerations for the security token. The security token may be part of a mobile phone having NFC capability, the first entity may be a Web service and the second entity may be a door controller. The Web service may establish a shared secret with the mobile phone. Providing secure communication with a security token may also include distributing the shared secret to all of the hosts corresponding to doors to which the phone can be used to obtain access.

### BACKGROUND OF THE INVENTION

1. Technical Field

This application is related to the field of secure communications and, more particularly, to cryptographic key management and the establishment of protected communication channel between entities.

2. Description of Related Art

Secure communications technology, such as GlobalPlatform secure channel, Opacity, IpSec, SSL/TLs etc., is available to allow two communicating systems equipped with cryptographic modules to exchange information with confidentiality and integrity protection. A mutual authentication allows both sides to authenticate each other. During the authentication step, a key establishment process establishes the same shared secret on each side, which may then be used to generate session keys for secure communication.

The shared secret may be established using any one of a number of techniques. For example, it is possible to use a public key infrastructure (PKI) key agreement technique such as Diffie-Hellmann to securely establish a shared secret. A trust relationship may be provided by the PKI, where each system hosts one or more PKI key pairs that may be certified to be bound to that system by a commonly trusted Certification Authority. The private keys may be independently managed and never shared, and the key pair certification occurs in advance of further authentication steps. Initial authentication using PKI includes one side proving that the other side owns a claimed private key by verifying the corresponding certificate and challenging the possession of the corresponding private key. PKI key agreement techniques may be performed with or without proof of ownership of private keys, or on one side only, like the commonly used SSL/TLS protocols. However such a proof is desirable on each side to gain assurance that the shared secret and the derived session keys can be trusted to protect communications with the other side.

Additional security techniques may be used during the key agreement step such as the generation of ephemeral keys and multiple combinations of ephemeral and static keys. Such techniques allow a relatively higher security level and add security features to the communication protection, such as privacy or forward secrecy as found in the Opacity full secrecy protocol. Another method to increase security level is to use static keys with longer bit lengths. All these security improvements are time and energy consuming. Another factor that may slow down the establishment of a shared secret is the power-up check of Cryptographic algorithms. According to FIPS 140-2 or 140-3 policies or equivalent, the cryptographic algorithms are tested before they are used. For example, if an elliptic curve operation is required to establish a shared secret, then it is performed twice (the test being the first time), which consumes time and energy.

In the case of secure contact or contactless transactions between a personal device (security token) equipped with a secure Integrated Circuit Chip (ICC), such as a smart card, and a secure access point host, such as a contactless door reader, sensitive identification information, credentials, digital tickets, value tokens, or secrets may be exchanged during the transaction. For practical use, or satisfactory user experience, contactless transactions may be limited in time, or may be required to avoid contact and allow a minimum distance between the ICC antenna and the reader. In some systems, the ICC may have an attached antenna and is powered by energy received from the door reader, which may be limited for practical reasons and/or by regulation. The energy that is available to the ICC decreases with the distance between the ICC antenna and the reader.

Using PKI key agreement techniques to initially establish secure communication for contactless-enabled ICCs and doors may be unacceptable; the time for executing the cryptography of the first PKI key agreement step inside the ICC of a personal security device with low computing power may be prohibitive and could cause the user to wait for access far longer than is practical. Note also that, for infrastructure legacy or cost reasons, an ICC device may not have a coprocessor specialized in the rapid processing of large numbers, which is useful for PKI key agreement techniques, further exacerbating the problem. In addition, the ICC may require more energy for the required computations than can be delivered to the card by a contactless door reader. These limitations prevent the deployment of PKI key agreement techniques (or similar techniques) with the desired key length or security protection level for use with contactless doors. In some cases, for contactless solutions with rapid transactions, performance is favored over security so that little or no protection for the communicated credential data is provided, thus making the system vulnerable to attack.

Accordingly, it is desirable to provide a system that makes shared secret establishment more efficient while maintaining the integrity of sensitive information used to establish a secure communication channel without introducing unacceptable delays.

### SUMMARY OF THE INVENTION

According to the system described herein, providing secure communication with a security token includes establishing a shared secret between the security token and a first entity, transferring the shared secret between the first entity and a second entity, and the security token and the second entity establishing a secure communication channel using the shared secret. The first entity may be a registrar. The second entity may be a host. The host may be coupled to a door controller and the security token may provide access through a corresponding door thereof. The first entity may be a host. The host may be coupled to a door controller and the security token may provide access through a corresponding door thereof. Transferring the shared secret may include selectively transferring the shared secret to a subset of entities according to access considerations for the security token. The security token may be part of a mobile phone having NFC capability, the first entity may be a Web service and the second entity may be a door controller. The Web service may establish a shared secret with the mobile phone. Providing secure communication with a security token may also include distributing the shared secret to all of the hosts corresponding to doors to which the phone can be used to obtain access.

According further to the system described herein, computer software, provided in a computer-readable medium, provides secure communication with a security token. The software includes executable code that establishes a shared secret between the security token and a first entity, executable code that transfers the shared secret between the first entity and a second entity, and executable code that causes the security token and the second entity to establish a secure communication channel using the shared secret. The first entity may be a registrar. The second entity may be a host. The host may be coupled to a door controller and the security token may provide access through a corresponding door thereof. The first entity may be a host. The host may be coupled to a door controller and the security token may provide access through a corresponding door thereof. Executable code that transfers the shared secret may selectively transfer the shared secret to a subset of entities according to access considerations for the security token. The security token may be part of a mobile phone having NFC capability, the first entity may be a Web service and the second entity may be a door controller. The Web service may establish a shared secret with the mobile phone. The computer software may also include executable code that distributes the shared secret to all of the hosts corresponding to doors to which the phone can be used to obtain access.

### BRIEF DESCRIPTION OF DRAWINGS

Embodiments of the system are described with reference to the several FIG.'s of the drawings, noted as follows.

FIG. 1 is a schematic diagram showing a security token, a registrar, and a host with the security token in communication with the registrar according to an embodiment of the system described herein.

FIG. 2 is a schematic diagram showing a security token, a registrar, and two hosts according to an embodiment of the system described herein.

FIG. 3 is a schematic diagram showing a security token, a registrar, and a host with the security token in communication with the host according to an embodiment of the system described herein.

FIG. 4 is a flow chart illustrating steps performed in connection with establishing a shared secret according to an embodiment of the system described herein.

FIG. 5 is a flow chart illustrating steps performed in connection with allowing or denying access according to an embodiment of the system described herein.

FIG. 6 is a flow chart illustrating steps performed in connection with establishing a shared secret according to an alternative embodiment of the system described herein.

FIG. 7 is a flow chart illustrating steps performed in connection with transferring a shared secret according to an embodiment of the system described herein.

FIG. 8 is a flow chart illustrating steps performed in connection with selectively determining which hosts obtain a shared secret according to an embodiment of the system described herein.

### DETAILED DESCRIPTION OF VARIOUS EMBODIMENTS

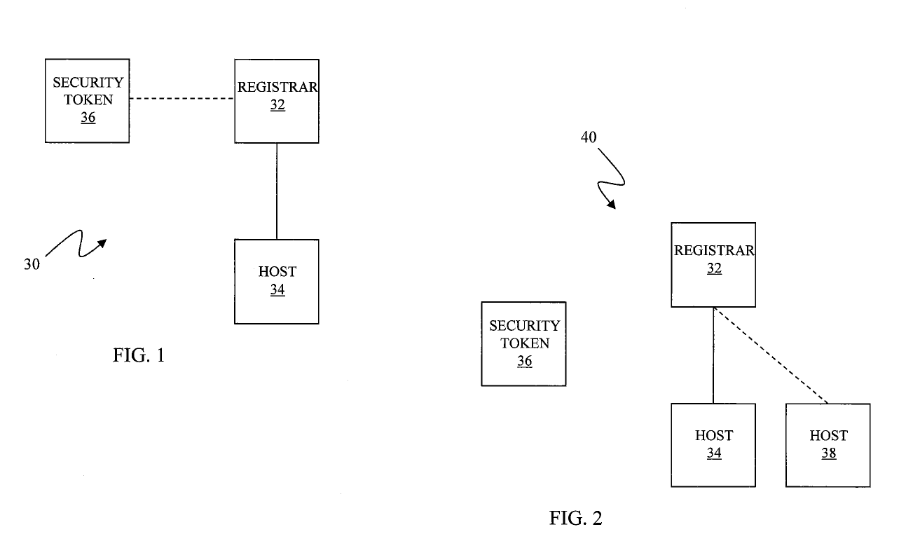

Referring to FIG. 1, a diagram 30 shows a registrar 32, a host 34, and a security token 36. The security token 36 may be a hardware based security device such as a smart card, an integrated circuit card, a subscriber identification module (SIM), a wireless identification module (WIM), an identification token, a secure application module (SAM), a hardware security module (HSM), a secure multi-media card (SMMC), a USB token, or a similar portable device that may be carried by a user for access.

The host 34 may be a computing device (e.g., a general purpose computing device) incorporated into a door or door controller for controlling physical access therethrough and/or may be incorporated into desktops, laptops and/or kiosks for controlling logical and/or physical access to another logical and/or physical entity (e.g., a computer file system). The host 34 may be used for payment transactions, loyalty transactions (e.g., frequent flyer miles, shopping points, etc.), and/or for any type of protected transaction and/or operation.

The host 34 may use PKI-based authentication and ticketing for transit applications and may be capable of establishing a logical communication channel with the security token 36 and capable of authenticating to the security token 36. The registrar 32 may be a general purpose computing device, such as a terminal or remote server, capable of establishing a logical communication channel with the security token 36 and capable of authenticating to the security token 36. The registrar 32 may be the same device or may be distinct from the host 34. The registrar 32 and the host 34 may be connected via the Internet, a private IP network, and/or any other appropriate mechanism for transmitting data therebetween.

The registrar 32 and the host terminal 34 communicate with the security token 36 to exchange data therewith as described elsewhere herein. The diagram 30 shows the security token 36 communicating with the registrar 32 to establish a shared secret between the security token 36 and the registrar 32. The term “shared secret” may be understood herein to include symmetric keys and session keys in which each side in a transaction may have the same or a different key that is used for secure communication therebetween. Generally, a shared secret should be understood herein to include data that is used to facilitate secure communication between two entities, is transferred from one entity to another, and needs to be maintained in secret to preserve confidentiality of the subsequent secure communication. A shared secret may be used by both sides of a transaction to generate session keys that are used for secure communication therebetween.

In an embodiment herein, establishing a shared secret may be performed by initially using a public key infrastructure (PKI) key agreement technique such as Diffie-Hellman and/or Elliptic Curve Diffie Hellman (ECDH) along with a public/private key pair of the security token 36 and a different public/private key pair of the registrar 32. PKI key agreement techniques are described, for example, in IpSec/IKE (Internet Key Exchange Specification) and National Institute of Standards and Technology (NIST) Special Publication 800-56A entitled “Recommendation for Pair-Wise Key Establishment Schemes Using Discrete Logarithm Cryptography” by Elaine Barker et al. (revised, March 2007), which is incorporated herein by reference. See also NIST Special Publication 800-56B for RSA Key transport and U.S. patent application 2004/0218762 titled “Universal Secure Messaging for Cryptographic Modules”, which is incorporated by reference herein. Note that any appropriate technique may be used to establish a shared secret between the security token 36 and the registrar, such as RSA key transport, which allows the system on one side to generate a shared secret that is involved in the computation of a session key that is transmitted securely using an authenticated public key bound to a private key of the system on the other side.

In an alternative embodiment, the security token 36 may be directly (physically) coupled to the registrar 32 (and/or a peripheral device thereof). In such a case, secure communication between the registrar 32 and the security device 36 may not be necessary since no information is transmitted. However, there may be instances where it is preferable to provide secure communication between the registrar 32 and the security device 36 even if a physical connection with no transmission is provided therebetween.

Referring to FIG. 2, a diagram 40 shows the security token 36 is shown as being disconnected from the registrar 32. The security token 36 may be disconnected after the shared secret is established between the registrar 32 and the security token 36 since, after establishment, the shared secret is separately stored within the registrar 32 and within the security token 36. The shared secret may be retained for a predetermined amount of time, or until a particular event, such as the security token 36 and/or the registrar 32 needing more memory space. Retention times/events may be different for the registrar 32 and the security token 36. Access to shared secret at the registrar 32 and/or at the security token 36 may be protected using a hardware cryptographic module and/or any other appropriate mechanism.

The shared secret may be transferred from the registrar 32 to the host 34 using any appropriate technique. In an embodiment herein, the shared secret may be transferred to the host 34 using the same or a similar technique as that used to initially communicate between the registrar 32 and the security token 34 (e.g., Diffie-Hellman and/or Elliptic Curve Diffie Hellman, etc.). Alternatively, any other technique may be used. For example, the registrar 32 and the host 34 may have a different shared secret that is used for confidential communication therebetween. The transfer may occur at any time after the shared secret is established, irrespective of whether the security token 36 is connected to another device. In some cases, the transfer may occur at the request host 34. That is, the host 34 may request the shared secret from the registrar 32. Access to shared secret at the host 34 may be protected using a hardware cryptographic module and/or any other appropriate mechanism.

In some cases, transfer of the shared secret from the security token 36 may include additional information, such as an expiration date, a list of authorized hosts, a list of authorized access times, etc. In some embodiments, the registrar 32 is coupled to a plurality of hosts and the shared secret is transferred to only a subset of the hosts to which the shared secret is allowed to be used. For example, if the hosts represent door controllers and the holder of the security token 36 is allowed access to a subset that is less than all of the doors corresponding to hosts coupled to the registrar 32, then the shared secret may be transferred only to the subset. This is illustrated in the diagram 40 by showing a second host 38 that is coupled to the registrar 32 that does not receive the shared secret from the registrar 32.

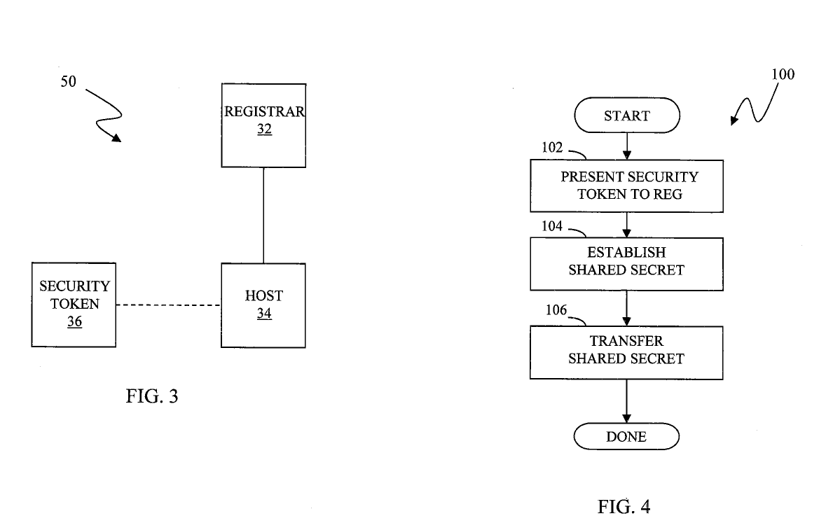

Referring to FIG. 3, a diagram 50 shows the security token 36 in communication with the host 34. The security token 36 and the host 34 may communicate using the shared secret that was previously established between the security token 36 and the registrar 32. Note that since the shared secret had been previously established and transferred to the host 34, the confidential communication between the host 34 and the security token 36 may be provided using the shared secret without any initial overhead for establishing the shared secret.

As a practical example, the security token 36 may be a user's subway access card, the registrar 32 may be a subway card kiosk (with a card reader), and the host 34 may be a gate controller that opens gates for accessing a subway system. The user could initially establish a shared secret between his subway card and the card kiosk that allows the user access to the subway system. In some cases, the user may need to make electronic/actual payment as an initial condition. The shared secret could then be transferred from the card kiosk to the gate controller. Subsequently, when the user attempts to walk through the subway gate, the subway card and the gate controller can communicate in a secure fashion relatively quickly since there will be no overhead to establish a shared secret when the user presents his card to the gate controller.

Referring to FIG. 4, a flow chart 100 illustrates steps performed in connection with the system described herein. Processing begins at a first step 102 where the security token 36 is presented to the registrar 32. Following the first step 102 is a step 104 where a shared secret is established between the security token 36 and the registrar 32. In an embodiment herein, authentication information may be initially generated at the registrar 32. A request may be sent from the registrar 32 to the security token 36 to authenticate the security token 36 to the registrar 32. The request may include at least a portion of the authentication information and may also include additional information used in the calculation of the shared secret, such as information about which target host(s) the shared secret will be transferred.

The system described herein may include sending only one request from the registrar 32 and receiving only one response from the security token 36. The request sent from the registrar 32 to the security token 36 may be unencrypted. The security token 36 may validate the authentication information. A response to the request at the registrar 32 may include information about the security token 36, and may include encrypted identification and optional authentication information such as an encrypted owner identification information and an optional certificate (i.e., a PKI certificate). The encrypted information in the response from the security token 36 may be encrypted using a portion of the authentication information. The encrypted information sent from the security token 36 to the registrar 32 may be decipherable by only the registrar 32 and/or only by the host 34.

Following the step 104 is a step 106 where the shared secret is transferred from the registrar 32 to the host 34. In addition to the shared secret, additional information may be transferred, such as identification information that identifies the security token 36 and optionally credential information from the registrar 32 to the host 34. The identification information that identifies the security token 36 may be used to reference or locate the shared secret. The credential information may be associated with the shared secret and may be encrypted with the shared secret. The credential information may be used to support an access decision by the host 34.

Optionally, the registrar 32 may verify information about the security token 36 and/or the owner thereof to determine a subset of target hosts prior to transferring the shared secret. In some cases, it is possible to determine whether one or more particular hosts are authorized to be recipients of the shared secret. The transfer of the shared secret between the registrar 32 and the host 34 may be manual or automated, using conventional key distribution techniques, or according to the description in U.S. Pat. No. 7,770,212 titled “SYSTEM AND METHOD FOR PRIVILEGE DELEGATION AND CONTROL”, which is incorporated by reference herein. An implementation may include protecting the shared secret end-to-end between a security module of the registrar 32 and a security module of the host 34. In some embodiments, the transfer of multiple shared secrets between the registrar and the host is done as a single transfer. Following the step 106, processing is complete.

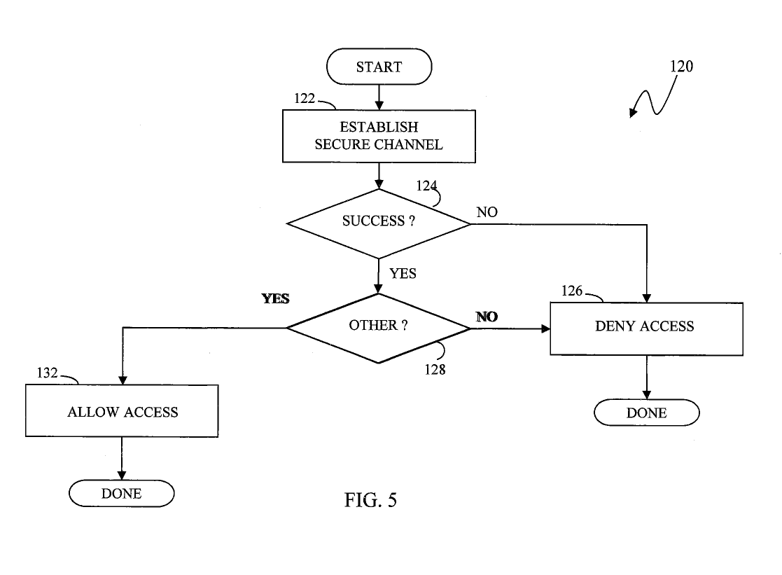

Referring to FIG. 5, a flow chart 120 illustrates steps performed in connection with presenting the security token 36 to the host 34 to determine whether to allow access to the holder of the security token 36. Processing begins at a first step 122 where an attempt is made to establish a secure communication channel between the security token 36 and the host 34. Establishing the secure communication channel at the step 122 may include submitting an authentication request when the security token 36 communicates with the host 34. The authentication request may include at least a portion of identification information for the registrar 32 and/or the host 34. When receiving the request, security device 36 may use the identification information to locate a corresponding shared secret. The security token 36 may then return a response that includes identification information of the security token 36, allowing the host 34 to locate the shared secret.

Optionally, the security token 36 may produce and return encrypted credential information for the security token 36 as part of the response or within subsequent responses. The encryption may use, for example, a session key derived from the shared secret. Upon reception of the response, the host 34 may locate the shared secret using at least a portion of the identification information of the security device 36. The shared secret can be then used to decrypt further communication between the host 34 and the security device 36. For instance, the shared secret can be used to decrypt the credential information for the security device 36 for an access decision at the host 34 or on behalf of the host 34. The host 34 may be a controlled access terminal and the security token 36 may request access to the controlled access terminal.

Following the step 122 is a test step 124 where it is determined if the host 34 and the security token 36 successfully established the secure communication channel using the shared secret at the step 122. There are a number of reasons why the host 34 and the security device 36 may not be able to establish the secure communication channel, including possible errors or possibly the holder of the security token 36 is not authorized at the host 34 and/or does not posses the shared secret. In any event, if the security token 36 attempts secure communication with the host 34 (or vice versa) using a shared secret not possessed by the other, or using an expired shared secret, or there is a failure for any other reason, then control transfers from the test step 124 to a step 126 where access is denied. The processing at the step 126 may include any appropriate actions, such as providing a message to a user, locking a door/gate, etc. Following the step 126, processing is complete.

If it is determined at the test step 124 that the host 34 and the security device 36 successfully establish a secure communication channel, then control transfers from the test step 124 to a test step 128 where it is determined if any other criteria that may be used indicate whether access should be allowed or denied. As discussed elsewhere herein, the other criteria may include examination of credentials, etc. That is, in some cases, it may be possible to establish a secure communication channel between the host 34 and the security token 36, but still deny access for other reasons based on other criteria. If it is determined at the test step 128 that the other criteria are not met, then control transfers from the test step 128 to the step 126, discussed above. Otherwise, control transfers to a step 132 where accessed is allowed. Following the step 132, processing is complete.

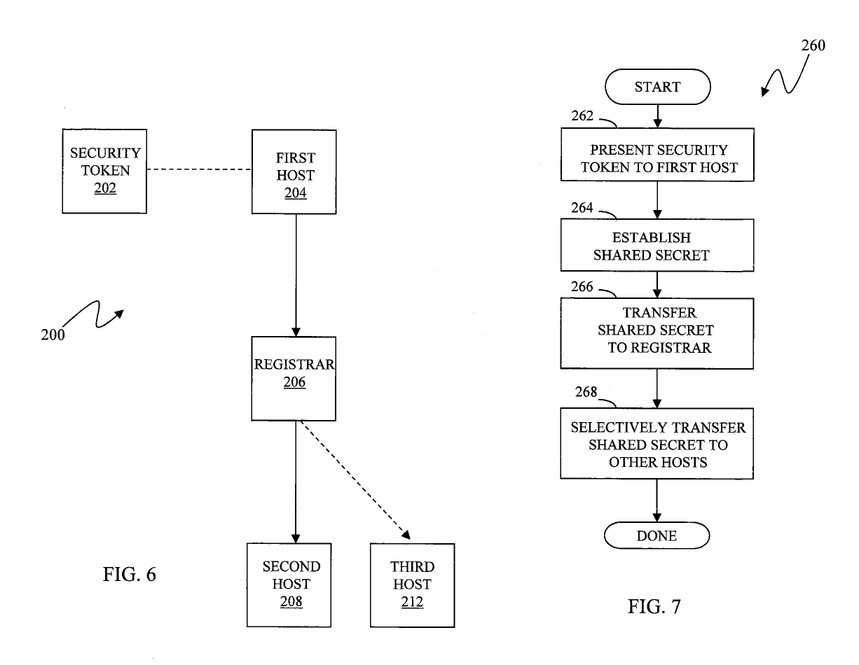

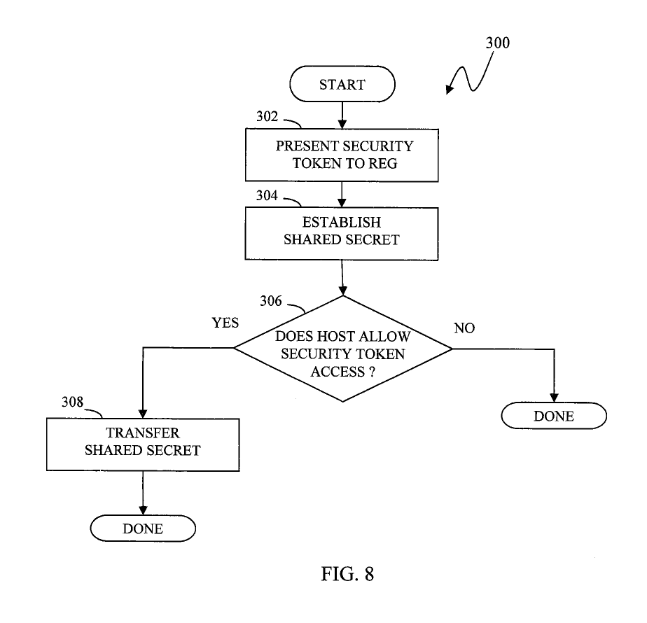

Referring to FIG. 6, a diagram 200 illustrates an alternative embodiment of the system described herein. In the embodiment illustrated by the diagram 200, a security token 202 establishes a shared secret with a first host 204, which provides the shared secret to a registrar 206. The shared secret may be transferred to the registrar 206 using any appropriate technique, such as Diffie-Hellman, Elliptic Curve Diffie Hellman, etc. and/or any other technique like those disclosed herein may be used. The first host 204 may be a computing device (e.g., a general purpose computing device) incorporated into a door or door controller for controlling physical access therethrough and/or may be incorporated into desktops, laptops and/or kiosks for controlling logical and/or physical access to another logical and/or physical entity (e.g., a computer file system).

The registrar 206 may selectively provide the shared secret to other hosts (e.g., the second host 208), but not to other hosts (e.g., the third host 212). The registrar 206 may use any appropriate criteria for selectively sharing the shared secret, including security/credential parameters. For example, if the hosts represent door controllers and the holder of the security token 202 is allowed access to a subset that is less than all of the doors, then the shared secret may be transferred only to the subset.

Referring to FIG. 7, a flow chart 260 illustrates steps performed in connection with the embodiment illustrated by the diagram 200 of FIG. 6. Processing begins at a first step 262 where the security token 202 is presented to the first host 204. Following the step 262 is a step 264 where a shared secret is established between the security token 202 and the first host 204. Following the step 264 is a step 266 where the shared secret is transferred to the registrar 206. Following the step 266 is a step 268 where the shared secret is selectively transferred from the registrar 204 to some of the other hosts. Following the step 268, processing is complete.

Referring to FIG. 7, a flow chart 300 illustrates steps performed in connection with a registrar selectively distributing the shared secret to a subset of hosts. Processing begins at a first step 302 where the security token is presented to the registrar. Following the first step 302 is a second step 304 where the security token and the registrar establish a shared secret. Note that, in embodiments where the shared secret may first be established between the security token and a first host (discussed above), the steps 302, 304 may be replaced by the registrar receiving the shared secret from the first host.

Following the step 304 is a test step 306 where it is determined if a particular host is to receive the shared secret (e.g., a host connected to a door to which a user allowed access with the security token). If not, then processing is complete. Otherwise, control transfers from the test step 306 to a step 308 where the security token is transferred to the host. Note that, in other embodiments, it is possible to selectively transfer (or not) the shared secret to a host at the request of a host. For, example, the registrar may initially not transfer the shared secret at all, but instead may wait for a request from a host. Upon receiving the request, the user determines if the host should receive the shared secret (e.g., a host connected to a door to which a user attempting to access with the security token) and then transfers the shared secret or not.

In another embodiment of the system described herein, the security token may not release privacy sensitive information in the clear. Instead, in the response from the security token, the identification information may be replaced with anonymous, one-time device identifier or may be encrypted. Credential information of the security token may always be encrypted. The security token and the registrar may determine a next value of the one-time identifier.

The high performance system for authentication described herein may secure physical access, logical access and/or transportation applications, among other implementations. The system provides authentication of a smart card and/or mobile phone with a secure element presented to one or more host terminals that may be incorporated into a door or door controller for controlling physical access, into desktops, laptops and/or kiosks for controlling logical access, and/or used in connection with PKI-based authentication and ticketing for transit applications.

In an embodiment, the registrar has a private key that is different from any keys used by the hosts. For instance, the security token may be part of a mobile phone having NFC capability and the registrar may be a Web service and the host may be a door controller. The Web service may establish a shared secret with the mobile phone, then distributes the shared secrets to all of the hosts corresponding to doors to which the phone can be used to obtain access.

In another embodiment, at least some of the hosts may be network nodes that also act as registrars. When a shared secret is established with a security token, the hosts may distribute the shared secret to other hosts, and optionally to an audit system as well.

The system described herein may be implemented using the any appropriate hardware capable of providing the functionality described herein. Thus, for example, the specific components illustrated herein may be replaced with similar components that provide appropriate functionality. It is also possible to provide additional components without departing from the spirit and scope of the invention.

Various embodiments discussed herein may be combined with each other in appropriate combinations in connection with the system described herein. Additionally, in some instances, the order of steps in the flowcharts, flow diagrams and/or described flow processing may be modified, where appropriate. Further, various aspects of the system described herein may be implemented using software, hardware, a combination of software and hardware and/or other computer-implemented modules or devices having the described features and performing the described functions. Software implementations of the system described herein may include executable code that is stored in a computer readable medium and executed by one or more processors. The computer readable medium may include a computer hard drive, ROM, RAM, flash memory, portable computer storage media such as a CD-ROM, a DVD-ROM, a flash drive and/or other drive with, for example, a universal serial bus (USB) interface, and/or any other appropriate tangible or non-transitory computer readable medium or computer memory on which executable code may be stored and executed by a processor. The system described herein may be used in connection with any appropriate operating system.

While the invention has been disclosed in connection with various embodiments, modifications thereon will be readily apparent to those skilled in the art. Accordingly, the spirit and scope of the invention is set forth in the following claims.

What is claimed is:

1. A method of providing secure communication with a security token, comprising:
establishing a shared secret between the security token and a first entity;
transferring the shared secret between the first entity and a second entity; and
the security token and the second entity establishing a secure communication channel using the shared secret.

2. A method, according to claim 1, wherein the first entity is a registrar.

3. A method, according to claim 2, wherein the second entity is a host.

4. A method, according to claim 3, wherein the host is coupled to a door controller and wherein the security token provides access through a corresponding door thereof.

5. A method, according to claim 1, wherein the first entity is a host.

6. A method, according to claim 5, wherein the host is coupled to a door controller and wherein the security token provides access through a corresponding door thereof.

7. A method, according to claim 1, wherein transferring the shared secret includes selectively transferring the shared secret to a subset of entities according to access considerations for the security token.

8. A method, according to claim 1, wherein the security token is part of a mobile phone having NFC capability, the first entity is a Web service and the second entity is a door controller.

9. A method, according to claim 8, wherein the Web service establishes a shared secret with the mobile phone.

10. A method, according to claim 9, further comprising:
distributing the shared secret to all of the hosts corresponding to doors to which the phone can be used to obtain access.

11. Computer software, provided in a computer-readable medium, that provides secure communication with a security token, the software comprising:
executable code that establishes a shared secret between the security token and a first entity;
executable code that transfers the shared secret between the first entity and a second entity; and
executable code that causes the security token and the second entity to establish a secure communication channel using the shared secret.

12. Computer software, according to claim 11, wherein the first entity is a registrar.

13. Computer software, according to claim 12, wherein the second entity is a host.

14. Computer software, according to claim 13, wherein the host is coupled to a door controller and wherein the security token provides access through a corresponding door thereof.

15. Computer software, according to claim 11, wherein the first entity is a host.

16. Computer software, according to claim 15, wherein the host is coupled to a door controller and wherein the security token provides access through a corresponding door thereof.

17. Computer software, according to claim 11, wherein executable code that transfers the shared secret selectively transfers the shared secret to a subset of entities according to access considerations for the security token.

18. Computer software, according to claim 11, wherein the security token is part of a mobile phone having NFC capability, the first entity is a Web service and the second entity is a door controller.

19. Computer software, according to claim 18, wherein the Web service establishes a shared secret with the mobile phone.

20. Computer software, according to claim 19, further comprising:
executable code that distributes the shared secret to all of the hosts corresponding to doors to which the phone can be used to obtain access.
